(19) United States
(12) Patent Application Publication
(10) Pub. No.: US 2007/0296873 A1
(43) Pub. Date: Dec. 27, 2007

(54) System Circuit Method for Utilizing Digital Memory Associated with a Host Device for Received Data

(76) Inventors: Alon Ironi, Haifa (IL); Dror Meiri, Haifa (IL)

Correspondence Address: EMPK & Shiloh, LLP, 116 JOHN ST,, SUITE 1201, NEW YORK, NY, 10038, US

(21) Appl. No.: 11/662,548

(22) PCT Filed:
(86) PCT No.: PCT/IL04/01082

Related U.S. Application Data
(60) Provisional application No. 60/610,201, filed on Sep. 16, 2004.

(51) Int. Cl. H04N 5/455; H04N 5/44

(52) U.S. Cl. 348/726; 348/553; 348/E05.113

(57) ABSTRACT

The present invention is a system, circuit and method of utilizing digital memory associated with a computing and/or communication device (c g. mobile or handheld phone or video based communication and presentation device). According to some embodiments of the present invention, a receiver or receiver sub-system functionally associated with the computing and/or communication device (c g a data receiving circuit, sub-system or module) may store data on a digital memory also functionally associated with the device. According to some embodiments of the present invention, the sub-system may include a receiver demodulator and may store data received from outside the device, either in a processed or in an unprocessed state, where the term processed may include functions like demodulated, decoded, error detected and/or error corrected. According to some embodiments of the present invention, preprocessed data stored by the sub-system on the digital memory may be read hack by the sub-system and processed.

### RELATED APPLICATIONS

This Patent Application is a Continuation-in-Part of U.S. Provisional Patent Applications Ser. No. 60/610,201, filed on Sep. 16, 2004, which is hereby incorporated by reference in its entirety.

### FIELD OF THE INVENTION

The present invention relates generally to the field of communications. More specifically, the present invention relates to a system, circuit and method for storing, retrieving and otherwise utilizing received data in digital memory associated with a computing and/or communication device to which a receiver may be connected.

### BACKGROUND OF THE INVENTION

Over the past decade, the prolife ration of handheld computing, entertainment and communication devices has been enormous. Many handheld devices include digital telecommunication and/or multimedia systems and require audio, video and graphics capabilities, and some even include television reception capabilities and wireless modem capabilities. Cellular phones, Palm-PCs, portable media players, digital video cameras and digital still cameras are examples of such systems.

Although each new generation of handheld devices tends to introduce new and innovative functionality, these devices are still required to be relatively small in size and economic considerations require their manufacturing cost to be as low as possible. Furthermore, since handheld devices must usually be battery-operated, there is also at times a strict requirement for the device to consume a small amount of power as possible. Low power consumption may allow for a relatively long operation time without having to replace or re-charge the batteries.

These requirements call for system architectures that are low in IC (integrated circuit) count, and deploy several layers of power saving. Each IC is required to have an architecture which is as small and cheap as possible, and consumes low power.

FIG. 1 shows a block diagram of an exemplary handheld device, the core of which device is a processor or microcontroller (host CPU) that may control the operation of the device and may execute many of the device's system tasks. It is interfaced with the applicative entities which may compose the device's system and various sub-systems. Among those entities there may be user interfaces, memories, multi-media encoders and decoders, graphic processors, mobile TV receivers, modems, other application specific processors, and a battery. Sometimes the host processor may also be responsible for performing application specific functions. For example, modern-day handheld devices are typically based on a strong host CPU with MPEG decoding and graphics control capabilities. Not all the blocks shown in FIG. 1 are mandatory for each type of device, however, a typical handheld device may be composed of some or all of the entities shown in the block diagram of FIG. 1.

User interface entities may include a color graphic display, an image sensor, a keypad, a speakerphone, a microphone or any other user input device known today or to be devised in the future. Modems can be cellular modems, wireless-LAN, Bluetooth, Mobile Digital Television (“MDTV”) demodulators or any other modems used today or to be devised in the future.

Digital memories used with a bandheld device may include DRAM, FLASH, EPROM, SIM card and hard disk. The DRAM is the most commonly used memory of host CPus today, and will be abbreviated here as “HDRAM” (Host DRAM) for convenience. The HDRAM is almost always a very large memory. In fact, modern handheld systems have HDRAM of size 256 Mbits to 1024Mbits.

Turning back to FIG. 1, there is seen that certain blocks (e.g. Modems, MDTV demodulator, Security, Audio and Video processors) can be referred to as “engines,” which engines engage in extensive data manipulation. These operations or data manipulation may vary with the application and functionality of the engine in terms of processing method, data rates, signal bandwidth, data precision and more. However, one of the common properties for the majority of those engines is that they are all required to store data and/or parameters as well as to buffer or manipulate it through processing and/or changing its order, insert or extract information from the data structure. Hence, they can all be considered RAM users or consumers.

As most systems associated with a handheld device are required to consume as little power as possible, it would be useful to operate any of the device's component or engines only when it is a must and to turn them off when it will not disturb any application requested by a user of the device. For example, it is of interest to put the display in a sleep mode when there is no essential information to be shown to the user, or to shut down the demodulator or portions of it when no data is expected to be received at that particular time instance. During such inactive periods, it might be required, however, to continue background processes such as to execute real time operations (e.g. timers, response to external requests, re-adjust parameters, acquire better quality RF signals and more) and to maintain data or parameter integrity by keeping it inside a RAM.

Thus, there is a need in the field of handheld computing and communication devices to reduce the size, cost and power consumption of various components and sub-systems associated with a handheld device. Furthermore, there is a need in the field for a method and system of optimizing digital memory utilization by various components and sub-systems of a bandheld device so as to provide for reduced sizes and lower power consumption.

### SUMMARY OF THE INVENTION

The present invention is a system, circuit and method of utilizing digital memory associated with a computing and/or communication device (e.g. mobile or handheld phone or video based communication and presentation device). According to some embodiments of the present invention, a sub-system functionally associated with the computing and/or communication device (e.g. a data receiving circuit, sub-system or module) may store data on a digital memory also functionally associated with the device. According to some embodiments of the present invention, the sub-system may include a receiver and may store data received from outside the device, either in a processed or in an unprocessed state, where the term processed may include functions like demodulated, decoded, error detected and/or error corrected. According to some embodiments of the present invention, preprocessed data stored by the sub-system on the digital memory may be read back by the sub-.system and processed. Processed data stored by the sub-system on the digital memory may be read or transmitted to other sub-systems functionally associated with the device. Once unprocessed data is read back to the sub-system and processed, it may either be transferred back to the digital memory functionally associated with the device or to another sub-system functionally associated with the device.

According to some embodiments of the present invention, the sub-system receiving data from outside the device may include a controller, which controller may communicate with a controller or a processor on the device in order to facilitate the transfer of data to and from the digital memory functionally associated with the device. The sub-system may also include a digital memory buffer, which buffer may store data received from outside the device. The sub-system controller may facilitate data transfers between the sub-system's digital memory buffer and the digital memory associated with the device.

The sub-system controller may facilitate the transfer of data stored by the sub-system in the digital memory functionally associated with the device back to the sub-system. The sub-system controller may facilitate the transfer of received data to the digital memory functionally associated with the device prior to the data being processed or decoded. The sub-system controller may facilitate the transfer of the unprocessed or un-decoded data back to the sub-subsystem for processing or decoding. And, according to some embodiments of the present invention, the controller may facilitate the transfer of processed or decoded data either to the digital memory functionally associated with the device or to another sub-system functionally associated with the device.

According to some embodiments of the present invention, the digital memory functionally associated with the device may be a Random Access Memory (“RAM”), either “S” or “D” type, connected to a controller of the device. The device controller may either be a multifunction or general purpose microprocessor, or the controller may be a dedicated memory access controller (e.g. Dynamic Memory Access unit “DMA”).

The sub-system may include a receiver or a modem, which is wireless, wired, optical, or of any other type known today or to be developed in the future. The sub-system may also include a decoder (e.g. turbo decoder) and/or an encoder. The sub-system and/or the decoder may include error detection and/or error correction functionality and logic circuits. The sub-system may also include data security (e.g. encryption and decryption) functionality and logical circuits.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram depicting various components and sub-systems which may be functionally associated with a mobile or handheld communication and/or computation device;

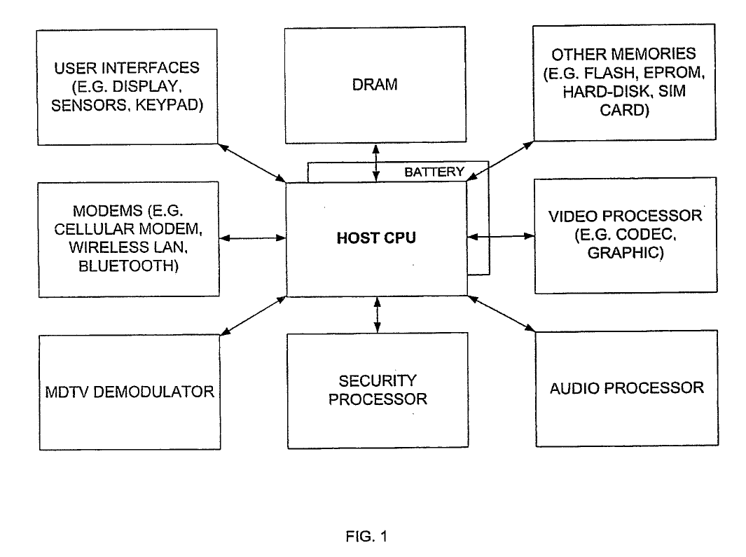

FIG. 2 is a block diagram of an exemplary arrangement of components and functional blocks of a mobile phone including a digital TV receiver according to some embodiments of the present invention;

FIG. 3 is a block diagram of an exemplary arrangement of components and functional blocks of a media player including a digital TV receiver according to some embodiments of the present invention;

FIG. 4 is block diagram of a data receiving circuit, including a host memory access controller or unit, according to some embodiments of the present invention; and

FIG. 5 is a block diagram of a data receiving circuit interconnected with a digital memory associated with a host device, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a system, circuit and method of utilizing digital memory associated with a computing and/or communication device (e.g. mobile or handheld phone or video based communication and presentation device). According to some embodiments of the present invention, a sub-system functionally associated with the computing and/or communication device (e.g. a data receiving circuit, sub-system or module) may store data on a digital memory also functionally associated with the device. According to some embodiments of the present invention, the sub-system may include a receiver and may store data received from outside the device, either in a processed or in an unprocessed state, where the term processed may include functions like demodulated, decoded, error detected and/or error corrected. According to some embodiments of the present invention, preprocessed data stored by the sub-system on the digital memory may be read back by the sub-system and processed. Processed data stored by the sub-system on the digital memory may be read or transmitted to other sub-systems functionally associated with the device. Once unprocessed data is read back to the sub-system and processed, it may either be transferred back to the digital memory functionally associated with the device or to another sub-system functionally associated with the device.

According to some embodiments of the present invention, the sub-system receiving data from outside the device may include a controller, which controller may communicate with a controller or a processor on the device in order to facilitate the transfer of data to and from the digital memory functionally associated with the device. The sub-system may also include a digital memory buffer, which buffer may store data received from outside the device. The sub-system controller may facilitate data transfers between the sub-system's digital memory buffer and the digital memory associated with the device.

The sub-system controller may facilitate the transfer of data stored by the sub-system in the digital memory functionally associated with the device back to the sub-system. The sub-system controller may facilitate the transfer of received data to the digital memory functionally associated with the device prior to the data being processed or decoded. The sub-system controller may facilitate the transfer of the unprocessed or un-decoded data back to the sub-subsystem for processing or decoding. And, according to some embodiments of the present invention, the controller may facilitate the transfer of processed or decoded data either to the digital memory functionally associated with the device or to another sub-system functionally associated with the device.

According to some embodiments of the present invention, the digital memory functionally associated with the device may be a Random Access Memory (“RAM”), either “S” or “D” type, connected to a controller of the device. The device controller may either be a multifunction or general purpose microprocessor, or the controller may be a dedicated memory access controller (e.g. Dynamic Memory Access unit “DMA”).

The sub-system may include a receiver or a modem, which is wireless, wired, optical, or of any other type known today or to be developed in the future. The sub-system may also include a decoder (e.g. turbo decoder) and/or an encoder. The sub-system and/or the decoder may include error detection and/or error correction functionality and logic circuits. The sub-system may also include data security (e.g. encryption and decryption) functionality and logical circuits.

Although various aspects and embodiments of the present invention are applicable to a multitude of components, systems and subsystem associated with a bandheld computing/communication device and/or to components, systems and sub-systems associated with larger computing/communication devices, certain aspect of the present may be described in the context of a handheld or mobile device including a Mobile Digital Television (“MDTV”) receiver and/or demodulator. It will be noted that for purposes of this application, the term video signal may include a video data stream or data, or any other media related data stream or data. The term video signal may also include an analog electromagnetic signal which has been modulated with video, sound and/or image related information.

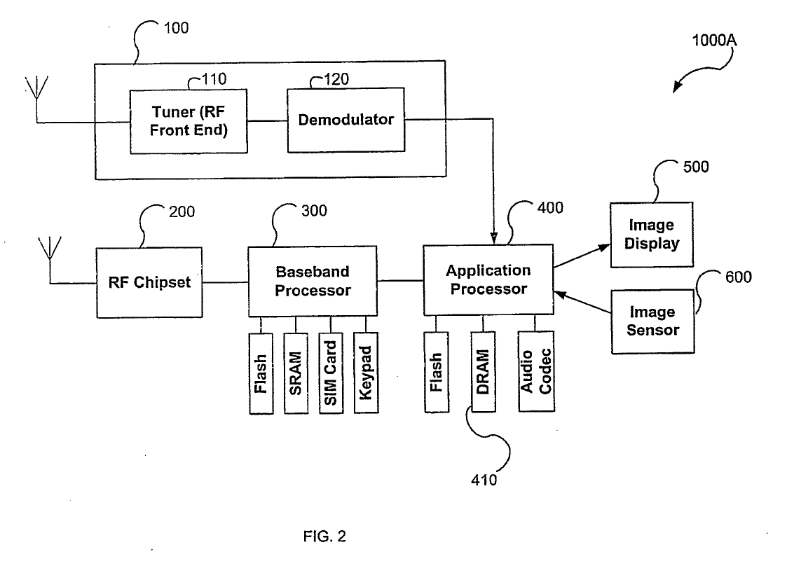

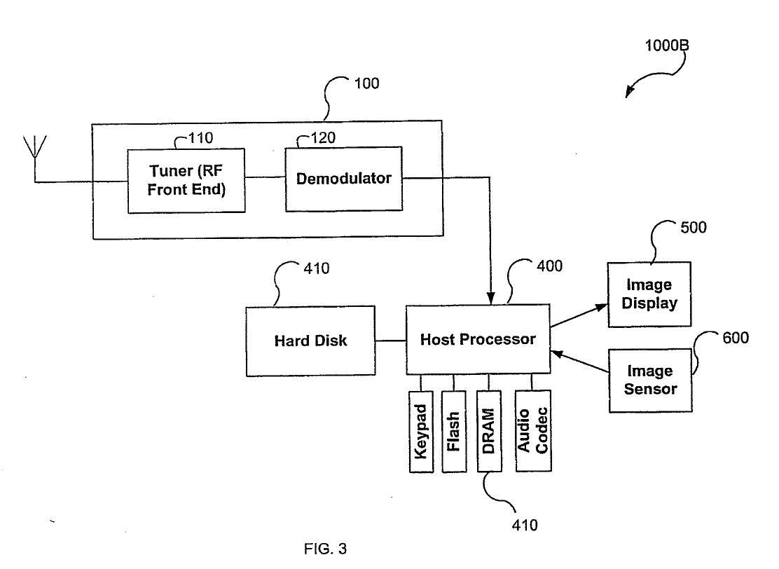

Block diagrams of implementations of a MDTV receiver/demodulators within a (1) mobile phone 1000A, and a (2) Portable Media Player (“PMP”) system 1000B, are shown in FIGS. 2 and 3, respectively. Turning to FIG. 2, there is shown that in addition to including the conventional radio frequency (“RF”) receiver chips 200 and base and processor 300 (e.g. demodulator, error detection, and error correction), a cellular handset 1000A according to the present invention may also include a second RF receiver 100 with a second RF chipset 110 and a second demodulator 120. According to some embodiments of the present invention, such as the ones shown in FIGS. 2 and 3, the second receiver 100 may be designed to receive data also containing video information, for example a data signal compliant with one or more of the standards associated with MDTV.

The Portable Media Player 1000B shown in FIG. 3 does not include a first or conventional receiver as shown in FIG. 2. However, both the cellular handset 1000A and the PMP 1000B according to the present invention may include digital memory 410 functionally associated or substantially integrally associated with a processor 400 or some other digital controller capable of managing access to a digital memory.

Integration of a METV receiver in a handheld device or terminal may result in additional power consumption. The budget for additional power consumption due to the additional MDTV receiver may be limited by specification, sometimes to as little as 10% of the expected power consumption of a standard Digital TV receiver (composed of RP tuner and a baseband demodulator).

Since, services used in mobile handheld devices or terminals require relatively lower bit rates than does for non-mobile devices, it may be possible to reduce energy consumption using various techniques which take advantage of the relatively low bit rate requirement. For example, since the estimated maximum bit rate for streaming video using advanced compression technology like MPEG-4 is on the order of a few hundred kilobits per second (Kbps), and since a popular digital video transmission standard, the Digital Video Broadcasting-Terrestrial (“DVB-T”), commonly used by demodulators for stationary TV reception usually provides a bit rate of up to 32 Mbps, a demodulator on handheld or mobile device or terminal may be able to operate only intermittently, and to remain inoperative more periods of time.

The DVB-H (H stands for handheld device) standard, may be used by a handheld demodulators, usually for mobile TV reception and may significantly reduce the average power consumption of a DVB receiver by introducing a scheme based on time division multiplexing (TDM). This scheme is called Time-Slicing. The concept of time-slicing is to send data in bursts using a significantly higher bit rate compared to the bit rate required if the data was transmitted continuously. Within a burst, the time to the beginning of the next burst (delta-t) may be indicated. This may enable a demodulator to stay active for only a fraction of a second, each second data is being transmitted, while receiving bursts of a requested service. If a constant lower bit rate is required by the mobile handheld terminal, this requirement may be provided by buffering the received bursts. To get a reasonable power saving effect, the burst bit rate may be about 10 times the constant bit rate of a delivered service. In case of a 350 Kbps streaming services, this indicates a requirement of 4 Mbps bit rate for the bursts.

US Patent Application Publication No. 20030152107 teaches: “In a digital broadband broadcasting system, in which information is transmitted and received periodically in bursts to reduce receiver power consumption, time-slice information is provided from the the transmitter to the receiver. The time-slice information can include information from which the receiver can determine when a subsequent transmission burst will be transmitted. The time-slice information can include a burst duration, an amount of time between original bursts, the time between an original burst and a copy of the burst, and numbering of original bursts. This type of time-slice information can be placed into packet headers, such as one or more bytes reserved, but not used, for media access control addressing ” (Publication Abstract).

Specific power consumption or savings depends on the duty cycle of the time-slicing scheme. A 10% duty cycle may lead to a 90% reduction in power consumption, assuming the demodulator can completely shut down during the no-duty period, when data is not being received. Power savings due to low duty cycles, however, also depend on how much of the demodulator can be turned off, during the inactive slot of that duty cycle. In an optimal situation, a receiver may take advantage of the time-slicing mechanism and may shut down as many functions as possible—essentially the entire receiver, and for the longest possible time—essentially the entire “silence” time.

Data received from a burst of data may, according to the DVB-H standard, may be used to produce a data structure called the MPE-FEC (Multi Protocol Encapsulation—Forward Error Correction) table. For a demodulator which is designed to support FEC, the size of this table may be about 2 Mbits, or up to 2.25 Mbits if it may support extended FEC capabilities, i.e. erasures handling. A demodulator which does not require having MPE-FEC capabilities may need a table of up to 1.5 Mbits.

Due to the data processing requirements of data received by a MDTV demodulator, namely the MPE-FEC table processing, even when a demodulator is not receiving data, the data received during a previous data burst may require storage and processing. As a consequence of having to store and process received data, an MDTV demodulator may be required to utilize at least 1.5 Mbits of memory, and also to access the memory and process data in the memory during time slots when the demodulator may otherwise be inactive.

According to some embodiments of the present invention, an MDTV may include embedded dynamic random-access memory (“DRAM”). Embedding logic/processing functions on the same semiconductor die as digital memory is well known. Alternatively, an MDTV demodulator may have its own digital memory, on a different die, but both packaged together. According to a further embodiment of the present invention, the MDTV demodulator may be connected to external and dedicated digital memory. Depending on the fabrication and processing technology used for the digital memory or buffer, the addition of 1.5 to 2.5 Mbits of digital memory to the die of a receiver or to the package within which the deceiver die resides, may lead to substantial size, fabrication complexity, and cost increases for the receiver. For example, a 2 Mbit memory cell array, including its controller, fabricated using 1.3 micrometer technology, may require more than 6.2 mm² of space on a die.

According to some embodiments of the present invention, such as the ones shown in FIGS. 2 and 3, data received by a receiver 100 may be stored outside the receiver and in a digital memory 410 which is functionally associated with a general purpose host processor 400 or functionally associated with a dedicated memory controller (not shown) on a host device to which the receiver is connected. Received data may be stored on the digital memory 410 in accordance with a service protocol between the receiver 100 and the processor 400, by which protocol the receiver 100 may request from the processor 400 accesses to a portion of the digital memory 410. Storing received data on a digital memory outside the receiver die and/or package, and avoiding the need for an integrated memory buffer of approximately 2 Mbits, may substantial reduce the size, fabrication complexity, and cost of a receiver according to some embodiments of the present invention.

An exemplary service protocol, according to some embodiments of the present invention, as the one described below, may be unified for all types of communications (except for configuration, which is done through the I2C-like port). Any data, control or payload, provided by the engine to the host may be structured as a packet with a packet header of 3 bytes. The following is the organization of the bits of a 3 byte, 24-bit, packet header. Note that bit 23 is the first one sent, bit 0 is the last one.

Bits 23-22—Message type
00—Service write request
01—Service read request
10—Service write response
11—Service read response

Bits 21-20—Message descriptor
00—Purpose 0
01—Purpose 1
10—Purpose 2
11—Purpose 3

Bits 19-18—Packet type:
00—Continuous Payload packet
01—Sparse Payload packet
10—TBD
11—TBD

Bits 17-16—packet status
00—middle packet (packet that is nor the first neither the last packet of one logical structure)
01—starting packet (packet that is the first packet of one logical data structure
01—ending packet (packet that is the last packet of one logical data structure)
11—TBD

Bits 15-0—packet size in Bytes (excluding the three header bytes)

In case the service is of type write request, the payload has three fields:

Field 1: Address of the first data byte in the HDRAM
Field 2: Size (in bytes) of the data, starting at the address given in field 1.
Field 3: The data payload which is requested to be written to the continuous address space starting in the address given in field 1 and ending after “field 2” bytes.
   In case the service is of type read request, the payload has only two fields:
Field 1: Address of the first data byte in the HDRAM
Field 2: Size (in bytes) of the data, starting at the address given in field 1.
   In case the service is of type read response the payload has three fields:
Field 1: Address of the first data byte in the HDRAM.
Field 2: Size (in bytes) of the data, starting at the address given in field 1.
Field3: The data payload which is requested to be read from the continuous address space starting in the address given in field 1 and ending after “field 2” bytes.
   In case the service is of type write response, it has the pure meaning of acknowledge, hence all the rest of the header bits are ignored and no payload data is sent from the HDRAM to the engine.
   Two types of payload packets are defined:

Continuous payload packet—is a packet whose payload data is continuous. This means that the address space into which the host is expected to write or to read from is continuous for the entire packet.

Sparse payload packet—is a packet whose payload data is not continuous, and can contain multiple addresses into which the host is expected to write or to read from during the same packet.

Two examples are given below:

### EXAMPLE 1

### Continuous Payload Packet

The engine sends to the host a write request (i.e. he wishes to write data to the HDRAM) for purpose 1. The data is continuous (one chunk of data) and it is the middle packet of the current procedure. The data is of size of 64 Kbytes, and the first data byte is written to address 0×A in the HDRAM.

In the following tables the header and payload fields are shown.

Packet Header Bytes:

| Message | | Message | | Packet | | Packet | | | | | | | | | | | | | | | | | |
|---|---|---|---|---|---|---|---|---|---|---|---|---|---|---|---|---|---|---|---|---|---|---|---|
| Type | | Descriptor | | Type | | Status | | Packet Size | | | | | | | | | | | | | | | |
| 23 | 22 | 21 | 20 | 19 | 18 | 17 | 16 | 15 | 14 | 13 | 12 | 11 | 10 | 9 | 8 | 7 | 6 | 5 | 4 | 3 | 2 | 1 | 0 |
| 0 | 0 | 0 | 0 | 0 | 0 | 0 | 0 | 1 | 1 | 1 | 1 | 1 | 1 | 1 | 1 | 1 | 1 | 1 | 1 | 1 | 1 | 1 | 1 |

Payload Fields:

| Address | Size | Data |
|---|---|---|
| 0x000000A | 0xFFFF | X |

### EXAMPLE 2

### Sparse Payload Packet

The engine sends to the host a read request (i.e. he wishes to read data from the HDRAM) for purpose 3. The data is sparse (more than one chunk of data) and it is the first packet of the current procedure. The data is of size of 2 Bytes, and is read from addresses 0×00F2 and 0×FF00.

In the following tables the header and entire payload fields are shown,

Packet Header Bytes:

| Message | | Message | | Packet | | Packet | | | | | | | | | | | | | | | | | |
|---|---|---|---|---|---|---|---|---|---|---|---|---|---|---|---|---|---|---|---|---|---|---|---|
| Type | | Descriptor | | Type | | Status | | Packet Size | | | | | | | | | | | | | | | |
| 23 | 22 | 21 | 20 | 19 | 18 | 17 | 16 | 15 | 14 | 13 | 12 | 11 | 10 | 9 | 8 | 7 | 6 | 5 | 4 | 3 | 2 | 1 | 0 |
| 0 | 1 | 1 | 1 | 0 | 1 | 0 | 1 | 0 | 0 | 0 | 0 | 0 | 0 | 0 | 0 | 0 | 0 | 0 | 0 | 0 | 0 | 1 | 0 |

Payload Fields:

| Address | Size | Address | Size |
|---|---|---|---|
| 0x00F2 | 0x0001 | 0xFF00 | 0x0001 |

Various service protocols for accessing digital memory associated with one controller or another are well known. Any service or memory access protocol known today or to be devised in the future may be applicable to the present invention.

According to some embodiments of the present invention, data received by a receiver, such as the MDTV receivers in FIGS. 2 and 3, may be temporarily and/or partially stored in a digital memory 410 associated with a host processor 400 during periods when the receiver is at least partially shut down. For example, during off-cycles, between the data burst duty cycles when the receivers 100 should be operational in order receive the bursts of data, a receiver according to some embodiments of the present invention may be able to shut down, at least partially, by first transferring some or all of the data received during a previous duty cycle to a digital memory 410 functionally associated with a host processor. Included in the data which may be transferred to or from the receiver to the digital memory is: (1) received data which has not yet been demodulated; (2) data which has not yet been error checked or error corrected; (3) any other data which requires additional processing within the receiver before being usable to a client application, (4) data associated with the physical operating parameters of the receiver (e.g. filter coefficients and WE-FEC tables), and (5) received data which requires data-rate equalization or bufferization, so as to provide the data to whichever given application it is intended for at a data-rate suitable for the given application. According to further embodiments of the present invention, data requiring further processing may be retrieved back into the receiver 100, once the receiver is turn back on. According to yet further embodiments of the present invention, data stored on the digital memory associated with the host, the host processor, or some other controller associated with the host, may be data-rate equalized in accordance with data rate requirements of a given application, when the processor or controller is providing the data to the given application.

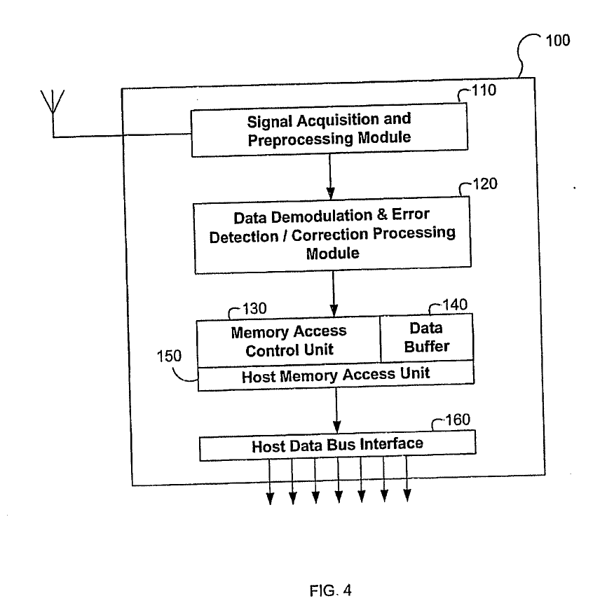

Turning now to FIG. 4, there is shown a block diagram of an exemplary receiver 100, according to some embodiments of the present invention, including a Signal Acquisition and Preprocessing Module 110 (e.g. filters, amplifiers, analog to digital converters, etc.). A Data Demodulation & Error Detection/Correction Processing Module 120 (e.g. demodulator with error detection/correction logic) may receive data from the Signal Acquisition and Preprocessing Module 110 and may attempt to demodulate the received data into order to produce a true copy of the source data within the received data. Various circuits, systems and methods for receiving transmitted signals, demodulating the received signals and extracting true and faithful copies of the source data contained in the transmitted signal are well know in the art of communication, and any such circuits, systems and methods known today or to be devised in the future may be applicable to present invention.

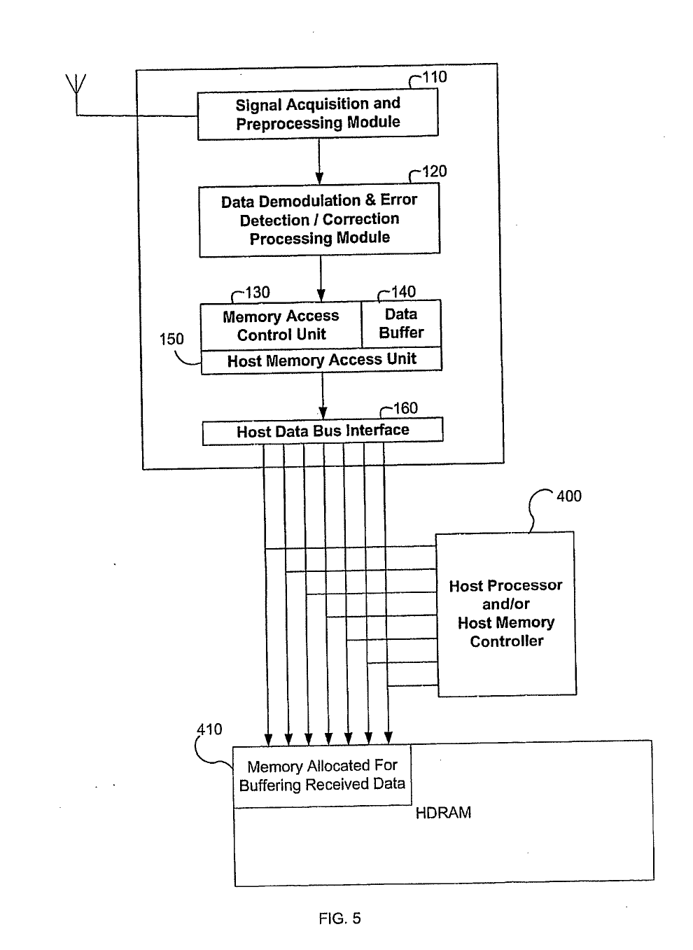

Portions or received data may be stored in a Buffer 140, either before or after processing. Under certain circumstances, such as when more data is received than can be buffered in Buffer 140, or when the receiver is about to shut down, according to some embodiments of the present invention, a Memory Access Control Unit 130 may facilitate the transfer of all or a portion of the received that to a digital memory 410 functionally associated with a processor 400, or memory controller, of a host device (also see FIG. 5). The Memory Access Control Unit 130 may communicate with the host processor 400, or host controller, using a service protocol, through a Host Memory Access Unit 150 and a Host Data Bus Interface 160.

According to some embodiments of the present invention, the receiver 100 may not be integrally connected to the host, but may be a separate and removable device which may be connected to the host through one of the host's external or peripheral interface ports or connection points, such as a Universal Serial Bus (“USB”), or through any other external/peripheral communication ports Known today or to be devised in the future. In cases where the receiver attaches to an external communication ports, such as a USB port, the receiver's Host Data Bus Interface 160 may be a communication module such as a USB communication module or circuit adapted to interface and communicate with the host device through the host's external communication port.

According to some embodiments of the present invention, the Memory Access Control Unit 130, operating in accordance with a given service protocol, may facilitate retrieval back into the receiver 100 of received data stored on the digital memory 410 associated with a host processor 400. Once retrieved into the receiver, data which has not been sufficiently demodulated or otherwise processed, may be further demodulate or processed by the Data Demodulation & Error Detection/Correction Processing Module 120.

According to some embodiments of the present invention, the writing and reading of data to and from the digital memory facilitate the rearrangement of data. For example, righting received data to the digital memory in a first order and reading it back in a second order may facilitate the interleaving or de-interleaving of the data. Various data manipulations are possible using read and write operations to the digital memory associated with the host device and/or host processor. Although data interleaving and de-interleaving were the two examples of data manipulation given as part of this application, any data manipulation known today or to be devised in the future may be applicable to the present invention.

According to some embodiments of the present invention, data exchange between the receiver (and/or any other data engine) and the digital memory (e.g. HDRAM) may utilize data bufferization in order to accommodate for delays imposed by processing and responses times in the processor or controller with which the digital memory is associated. There are several parameters in a host device or system, which may impact the feasibility of this solution, and which may require a certain minimal size for a buffer. In order to define the buffering parameters, according to some, but not all, examples of the present invention the following assumptions may be made:
THR (Host Response Time): the maximum time from the instance when the engine submits a service request, until the host starts servicing this request. A common practice value for THR is 1 ms.
THDD (Host Data Delivery Time): the time it takes the host, once it has started servicing the receiver, to move one byte of data from the HDRAM to the receiver, or vice versa. This is practically the inverse of the byte-rate over the virtual bus connecting the receiver and the HDRAM, i.e. THDD[sec]=1/RHDD [byte/sec]. A common practice values for RHDD are 8 Mbps, 20 Mbps and over 160 Mbps for USB 1.1, SPI and fast parallel interface of 16 bits width, respectively.
RID (Incoming Data Rate): the internal byte data rate at the receiver. Typical values depend on the specific application of the receiver, as example the MDTV demodulator's data rate during a burst might be up to 32 Mbps.
REP (Receiver Processing Rate): processing rate of the receiver in terms of byte per second, which is the inverse of the time it takes the receiver to process one byte extracted from the HDRAM.
B: size in bytes of the internal buffer at the receiver.

The receiver may require an internal buffer to compensate for the latency in the host response. Assuming the policy is for the receiver to request host (memory) service when the buffer is half full (B/2), and deliver half a buffer each time, the following relations shall may exist:
For HDRAM utilized as a data buffer:
THR+B/(2 RHDD)<B/(2 RID)

The meaning of these formulas or relations is that the buffer may be sufficiently large such that once the receiver requests a service, there is enough time for the host to respond to the service request, and move data from the buffer to the HDRAM before the buffer is overflows because of fresh incoming data. Thus, the minimum buffer size may be given by:

B>2THR/(1 /RID-1/RHDD)

As an example, with THR=1 ms; RID=32 Mbps; RHDD=160 Mbps fast parallel interface) the buffer size will be B>80 Kbits.

In such a case 40 Kbits will be sent per a single service request, and 2 bits data download to the HDRAM will last 62.5 milliseconds.

For RID=1.5 kbps, B is negligible.

For HDRAM utilized as a data-pump:

(THR+B/(2 RHDD))<B/(2 REP).

The meaning of this requirement is that the buffer is sufficiently large such that once the receiver requests a service. There is enough time for the host to respond to the service request, send data from the HDRAM to the buffer for processing, move processed data back from the buffer to the HDRAM and all of this before the processing unit overflows the buffer with a new processed data. Thus, the minimum buffer size is given by:

B>2 THR/(1/REP−1/RHDD)

If REP<RID the buffer size will be smaller, which is good, however for our example, it would take 0.5 seconds to perform FEC for the entire table, which will be on the expense of the off-time, and hence will not be power efficient.

On the other hand If REP>RID the buffer size will be larger, however, the time for the decoding of the entire table will be approximately inversely proportional.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A data receiving or processing circuit for a host device comprising:
(a) a data processing unit or demodulator to process or demodulate received data; and
(b) a host memory access unit to provide said data processing unit or demodulator access to digital memory functionally associated with said host device, such that said data processing unit or demodulator may utilize said digital memory to process or demodulate received data.

2. The circuit according to claim 1, further comprising a internal buffer to buffer data transferred between said receiving circuit and the digital memory.

3. The circuit according to claim 2, wherein said data buffer is substantially smaller than an amount of data said receiver anticipates over a predefined period.

4. The circuit according to claim 2, wherein said data buffer is substantially smaller than the amount of memory allocated for received data demodulating or processing in the digital memory functionally associated with said host device.

5. The circuit according to claim 4, wherein said data buffer is substantially smaller than one and a half megabits.

6. The circuit according to claim 1, wherein said host memory access unit transfers data to and from the digital memory functionally associate with said host device by communicating with a memory controller in accordance with a service protocol.

7. The circuit according to claim 6, wherein the memory controller from which said memory access unit requests memory access is a processor of said host device.

8. The circuit according to claim 6, wherein said memory access unit facilitates the writing of data to the digital memory functionally associate with said host device.

9. The circuit according to claim 7, wherein said memory access unit may facilitate the reading of data from the digital memory functionally associate with said host device.

10. The circuit according to claim 9, wherein said memory access unit may facilitate the writing of data to the digital memory in a first pattern and may facilitate the reading of data from the digital memory in a second pattern.

11. The circuit according to claim 9, wherein said memory access unit may facilitate interleaving and de-interleaving of data written to and read from the digital memory.

12. The circuit according to claim 8, wherein said data processing unit or demodulator is adapted to process or demodulate data associated with a video signal.

13. The circuit according to claim 8, wherein said data processing unit or demodulator is adapted to process or demodulate data associated with I.P. data casting.

14. The circuit according to claim 8, wherein said data processing unit or demodulator is adapted to process or demodulate data associated with a video data according to one or more standards selected from the group consisting of DVB-H, DVB-T, DMB, ISDB, ATSC, DAB and IBOC.

15. The circuit according to claim 11, further comprising an internal buffer wherein said data buffer is substantially smaller than one and a half megabits.

16. The circuit according to claim 15, wherein the memory controller from which said memory access unit requests memory access is a processor of said host device.

17. A Mobile Digital Television (“MDTV”) receiving or processing module for a host device comprising:
(a) a data processing unit or demodulator to process or demodulate received data; and
(b) a host memory access unit to provide said data processing unit or demodulator access to digital memory functionally associated with said host device, such that said data processing unit or demodulator may utilize said digital memory to process or demodulate received data.

18. The module according to claim 17, further comprising an internal buffer to buffer a portion of data transferred between said receiving circuit and the digital memory.

19. The module according to claim 18, wherein said data buffer is substantially smaller than an amount of data said receiver anticipates over a predefined period.

20. The module according to claim 18, wherein said data buffer is substantially smaller than the amount of memory allocated for received data demodulating or processing in the digital memory functionally associated with said host device.

21. The module according to claim 18, wherein said data buffer is substantially smaller than one and a half megabits.

22. The module according to claim 17, wherein said host memory access unit transfers data to and from the digital memory functionally associate with said host device by communicating with a memory controller in accordance with a service protocol.

23. The module according to claim 22, wherein the memory controller from which said memory access unit requests memory access is a processor of said host device.

24. The module according to claim 22, wherein said memory access unit facilitates the writing of data to the digital memory functionally associate with said host device.

25. The module according to claim 22, wherein said memory access unit may facilitate the reading of data from the digital memory functionally associate with said host device.

26. The module according to claim 25, wherein said memory access unit may facilitate the writing of data to the digital memory in a first pattern and may facilitate the reading of data from the digital memory in a second pattern.

27. The module according to claim 26, wherein said memory access unit may facilitate interleaving and de-interleaving of data written to and read from the digital memory.

28. The module according to claim 17, wherein said data processing unit or demodulator is adapted to process or demodulate data associated with a video signal.

29. The module according to claim 17, wherein said data processing unit or demodulator is adapted to process or demodulate data associated with I.P. data casting.

30. The module according to claim 17, wherein said data processing unit or demodulator is adapted to process or demodulate data associated with a video data according to one or more standards selected from the group consisting of DVB-H, DVB-T, DMB, ISDB, ATSC, DAB and IBOC.

31. The module according to claim 17, wherein received data is received during data bursts and stored in said digital memory between or for a fraction of time between data bursts while said MDTV receiving module is substantially inactive.

32. The module according to claim 17, wherein the host device is selected from the group consisting of a host mobile phone, a laptop computer, a personal digital assistant, a digital camera, a portable game counsel, and any other host device with a display.

33. The module according to claim 27, further comprising an internal buffer, wherein said buffer is substantially smaller than one and a half megabits.

34. The module according to claim 33, wherein said data processing unit or demodulator is adapted to process or demodulate data associated with a video data according to one or more standards selected from the group consisting of DVB-H, DMB, ISDB, ATSC, DAB and IBOC.

35. The module according to claim 34, wherein received data is received during data bursts and stored in said digital memory between or for a fraction of time between data bursts while said MDTV receiving module is substantially inactive.

36. The module according to claim 17, further comprising;
(a) an internal buffer to buffer a portion of data transferred between said module and the digital memory; and
a host data bus interface unit adapted to communicate with an external or peripheral communication port of the host device, thereby providing said host memory access unit access to the digital memory through the external or peripheral communication port of the host device.

37. A method of receiving data in a host device, said method comprising:
(a) digitizing a received signal to produce a set of data; and
(b) utilizing digital memory functionally and substantially integrally associated with a processor of the host device as part of demodulating the data.

38. The method according to claim 37, further comprising adhering to a service protocol in order to establish a logical connection with the digital memory substantially integrally associated with a processor of the host device.

39. The method according to claim 38, wherein adhering to a service protocol includes issuing a write request to write data to the digital memory substantially integrally associated with a processor of the host device.

40. The method according to claim 39, wherein adhering to a service protocol includes issuing a read request to read data from the digital memory substantially integrally associated with a processor of the host device.

41. The method according to claim 39, further comprising buffering a portion of the data to be written to the digital memory in an intermediate buffer.

42. The method according to claim 39, wherein the intermediate buffer is substantially smaller than all amount of memory allocated for received data demodulating or processing in the digital memory functionally associated with host device.

43. The method according to claim 39, wherein said data buffer is substantially smaller than two megabits.

44. The method according to claim 39, wherein patterns by which data is written to and read data from the digital memory differ so as to facilitate the interleaving and de-interleaving of the data.

45. The method according to claim 39, wherein data written and read back from the digital memory may be associated with Multi-Protocol-Encapsulation-Forward-Error-Correction (“MPE-FEC”) Table.

46. The method according to claim 39, wherein the received data is associated with video data according to one or more standards selected from the group consisting of, DVB-H, DVB-T, DMB, ISDB, ATSC, DAB and IBOC.

47. A method of receiving Mobile Digital Television (“MDTV”) data in a host device, said method comprising:
(a) digitizing a received signal to produce a set of data; and
(b) utilizing digital memory substantially integrally associated with a processor of the host device as part of demodulating the data.

48. The method according to claim 47, further comprising adhering to a service protocol in order to establish a logical connection with the digital memory substantially integrally associated with, a processor of the host device.

49. The method according to claim 48, wherein adhering to a service protocol includes issuing a write request to write data to the digital memory substantially integrally associated with a processor of the host device.

50. The method according to claim 49, wherein adhering to a service protocol includes issuing a read request to read data from the digital memory substantially integrally associated with a processor of the host device.

51. The method according to claim 49, further comprising buffering a portion of the data to be written to the digital memory in an intermediate buffer.

52. The method according to claim 49, wherein the intermediate buffer is substantially smaller than an amount of data anticipated over a predefined period.

53. The method according to claim 49, wherein said data buffer is substantially smaller than one and a half megabits.

54. The method according to claim 49, wherein patterns by which data is written to and read from the digital memory differ so as to facilitate the interleaving and de-interleaving of the data.

55. The method according to claim 49, wherein data written and read back from the digital memory may be associated with Multi-Protocol-Encapsulation-Forward-Error-Correction (“MPE-PEC”) Table.

56. The method according to claim 49, wherein the received data is associated with video data according to one or more standards selected from the group consisting of DVB-H, DVB-T, DMB, ISDB, ATSC, DADE and IBOC.

57. The method according to claim 49, wherein data is received during data bursts and stored on the digital memory between or for a fraction of time between data bursts while a data receiver is substantially shut down.

58. The method according to claim 49, wherein the host device is selected from the group consisting of a host phone, a laptop computer, a personal digital assistant, a digital camera, a portable game counsel, and any other host device with a display.

59. The method according to claim 47, wherein the host device is a removal device which interfaces with a host device through an external communication or peripheral port of the host device.

60. A Mobile Digital Television (“MDTV”) receiving module for a host device comprising:
(a) a data processing unit or demodulator to process or demodulate received data; and
(b) an internal buffer to buffer associated with said data processing unit, wherein said data buffer is substantially smaller than an amount of data said receiver anticipates over a predefined period.

61. The module according to claim 60, wherein said data buffer is substantially smaller than the amount of memory allocated for received data demodulating or processing in the digital memory functionally associated with said host device.

62. The module according to claim 61, wherein said data buffer is substantially smaller than one an a half megabits.

63. The module according to claim 60, further comprising a host data bus interface unit adapted to communicate with an external or peripheral communication port of the host device, thereby providing a host memory access unit access to digital memory functionally associated with the host device through the external or peripheral communication port of the host device.
